(19) United States
(12) Patent Application Publication
(10) Pub. No.: US 2017/0213270 A1
(43) Pub. Date: Jul. 27, 2017

(54) PROVISIONING AND DELIVERING INFORMATION ASSOCIATED WITH REAL-WORLD OBJECTS

(71) Applicant: Aintu Inc., San Jose, CA (US)

(72) Inventor: Arthur Vaysman, San Jose, CA (US)

(21) Appl. No.: 15/413,235

(22) Filed: Jan. 23, 2017

Related U.S. Application Data
(60) Provisional application No. 62/286,309, filed on Jan. 22, 2016.

(51) Int. Cl. G06Q 30/06; H04L 29/06; G06K 7/10

(52) U.S. Cl. CPC G06Q 30/0625; G06K 7/10722; H04L 63/083

(57) ABSTRACT

A method for providing product information associated with a manufactured product is provided. The method comprises generating a unique identifier for said product; encoding said identifier in a Computer Readable Code (CRC); associating said CRC with said product; maintaining a database comprising product information associated with said product indexed based on said unique identifier; and providing a lookup application to capture an image of said CRC and to engage in a lookup process with said database to retrieve said product information.

### FIELD

Embodiments of the present invention relate to information. In particular, embodiments of the invention relate to the delivery of information associated with products.

### BACKGROUND

Consumers may benefit from information associated with products. For example, consider a manufactured product such as a “printer” may have important information for a consumer in the form of user manuals, product guides, installation guides, troubleshooting guide', and other product literature. Additionally, the product information may also include ordering information for consumables associated with the printer. For example, one consumable associate with the printer include an ink cartridge placement.

### SUMMARY

In one aspect of the invention, there is provided a system and method to provide information associated with a manufactured product. The method includes the placement of a Computer-Readable Code (CRC) on the packaging associated with goods, on the goods themselves. To obtain the information, (A) the CRC is scanned by taking an image of it, for example by using the camera of a mobile phone; and (B) the CRC is recovered from the image and transmitted to an Information Server (IS). The IS retrieves the information associated with the manufactured product and transmits it to the mobile phone.

Other aspects of the invention include the generation of the CRC's, and the provisioning and maintenance of informational databases that contain product information in order to service an information request.

Other aspects of the invention will be apparent from the detailed description below.

### BRIEF DESCRIPTION OF THE FIGURES

FIG. 1 shows a deployment drawing in accordance with one embodiment of the invention

FIG. 2A shows a real-world object in the form of a printer bearing a computer-readable code, in accordance with one embodiment of the invention.

FIG. 2B shows the computer-readable code in greater detail, in accordance with one embodiment of the invention.

FIG. 3 illustrates how information in an information database may be organized, in accordance with one embodiment of the invention.

FIG. 4 illustrates a process for generating unique identifiers, in accordance with one embodiment of the invention.

FIG. 5 illustrates an information lookup process, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

In accordance with one embodiment of the invention, a computer-readable code (CRC) is associated with an object in the real world. For example, the object may be a manufactured product such as a printer, television, microwave, etc. Advantageously, the CRC may be disguised or obfuscated with a graphical element such as a logo. Ideally, the logo may be well known by virtue of enjoying widespread distribution. The logo may be scanned by a user and transmitted to an Information Server (IS) configured to look-up and deliver information associated with the logo, as will be described.

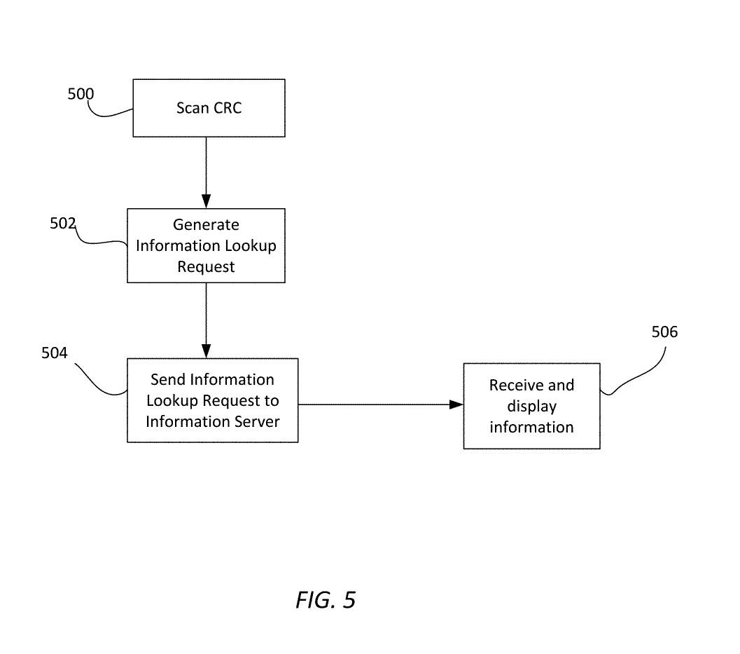

In accordance with one embodiment of the invention, a Lookup Application 10 is provisioned in a client device, such as a Mobile Phone 12. The Lookup Application 10 includes a Scan Function 52 (see FIG. 5) capable of scanning a Computer Readable Code (CRC) 16 associated with a real-world object in the form of a Product 14. The Product 14 may generally comprise an article of manufacture as described above. More particularly, CRC 16 may be printed on or affixed to product packaging associated with the Product 14 or directly on the Product 14 itself.

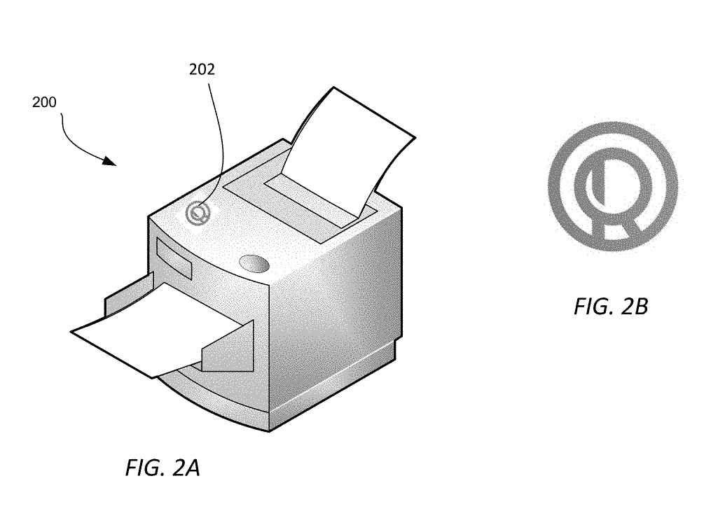

In one embodiment, the CRC 16 may comprise an optically readable code akin to a QR code. For example, referring to FIG. 2 an article of manufacture in the form of a Printer 200 includes a CRC 202 affixed to an upper surface. The CRC 202 is shown in greater detail in FIG. 2B, in accordance with one embodiment.

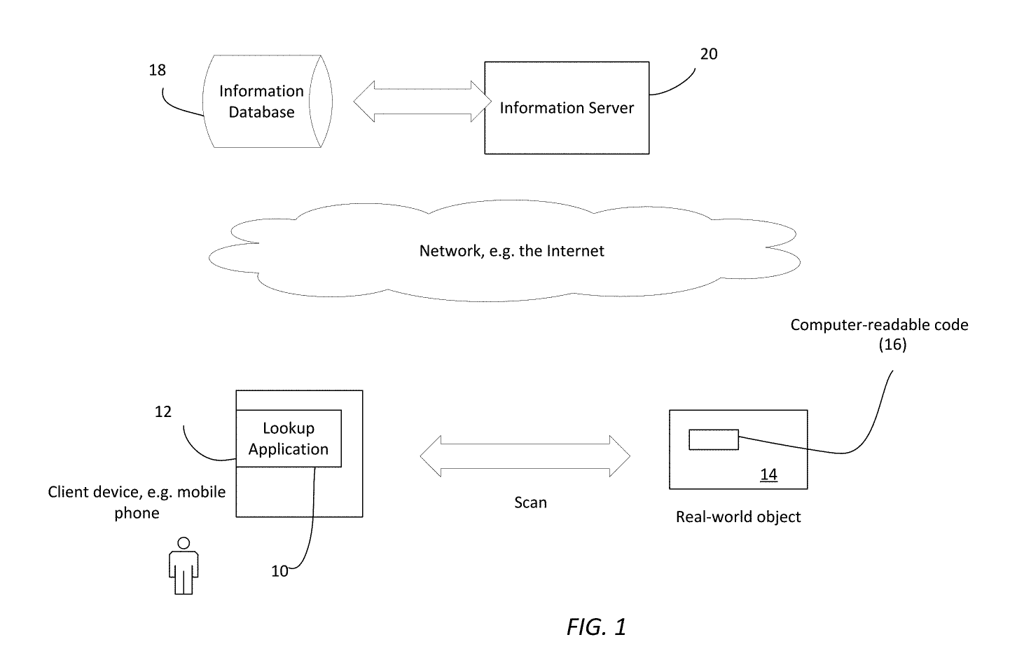

In accordance with one use case for the technology disclosed herein, a manufacturer of the Printer 200 may wish to provide certain information related to the printer. Such information is also referred to herein as “product literature” or as “product information”. For example, the product information may include operating instructions for the printer, troubleshooting information, and ordering information for consumables associated with the printer, such as toner ink cartridges compatible with the printer. The information may be provisioned in an Information Database 18, as can be seen in FIG. 1. Referring to FIG. 1, the Information Database 18 is communicatively coupled to an Information Server 20. In one embodiment, the Information Server 20 comprises functionality to service an information request generated by the Lookup Application 10, as will be described in greater detail below.

In one embodiment, the Information Server 20, and the Information Database 18 may be deployed in the cloud. Typically, the Information Server 20, and the Information Database 18 are under control of an Operator (not shown) who operates an Information Service in order to provide information associated with real-world objects. Advantageously, the Information Database 18 is a private database which is not generally accessible to third parties. Thus, the Operator may exercise control over the information input into the Information Database 18. In one embodiment, the information provisioned in the Information Database 18 may be obtained from the manufacturers of products and the Operator assumes control for inputting said information into the Information Database 18. In some cases, the Operator may allow manufacturers to input the information into the Information Database 18, directly.

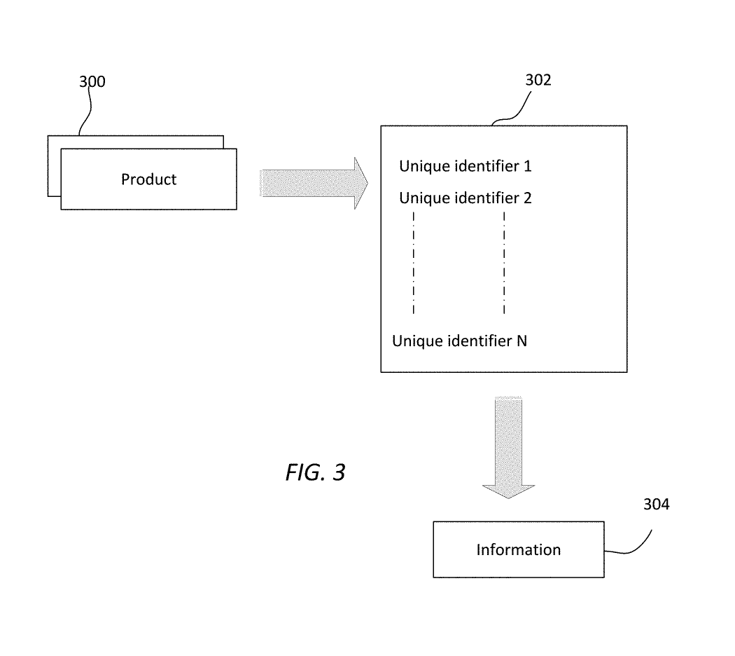

FIG. 3 indicates an organizational structure for the Information Database 18, in accordance with one embodiment of the invention. Referring to FIG. 3, the Information Database 18 comprises a plurality of Products 300. Each Product 300 may be uniquely identified by a SKU number. Each Product 300 is mapped to a Set 302 of unique identifiers. Each unique identifier in the Set 302 may be generated by a manufacturer of the product or by some entity authorized to do so by said manufacturer. For example, in one embodiment the Information Server 20 may include a component configured to generate the set of unique identifiers for a given product of a manufacturer.

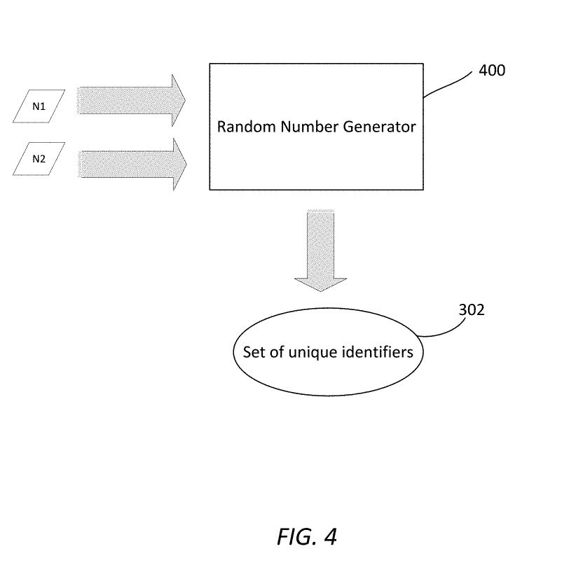

FIG. 4 illustrates a process, in accordance with one embodiment, to generate the Set 302 of random numbers. As will be seen, the process includes inputting two numbers N1 and N2 into a Random Number Generator (RNG) 400. The number N1 specifies the number of digits that a random number output by the Random Number Generator 400 must have. The number N2 specifies the number of random numbers within the set clear to of random numbers. For example, a manufacturer of printer may instruct the Operator to generate a million random numbers (this number corresponds to the number N2) to be used in association with printers made by the manufacturer. Thus, the Set 302 will comprise one million random numbers. In one embodiment, the Operator may operate on an on-demand basis to generate random numbers to be used as a basis for deserving information associated with the products of various manufacturers. This means that when a manufacturer requires a certain number of random numbers, then said manufacturer will make a request to the service provider to generate that number of random numbers. Various techniques may be used to generate the set of unique identifiers. In one embodiment, each unique identifier has sufficient bits to reduce the likelihood of said identifier being replicated by an unauthorized party. Thus, for example, in one embodiment each random number corresponding to a unique identifier in the Set 302 may comprise 128 bits which would make about 3.4×10̂38 random numbers available for inclusion in the Set 302. In this case, because the number of random numbers available for use as unique identifiers is very high, the likelihood of an unauthorized party being able to correctly identify the numbers in the Set 302 is very small.

Once the random numbers are generated, there are various use cases that may be employed in order to produce the computer-readable codes that each embody a random number.

Under a first use case, the random numbers are given to the manufacturer who may then oversee operations to place the random numbers on product packaging. In one embodiment, an encoder may be provided to the manufacturer to enable the manufacturer to encode each random number in a computer-readable code. Each computer-readable code may be printed on a sticker or label which may be affixed to product packaging.

Under a second use case, under the authority of the manufacturer, the Operator may oversee operations to place the random numbers on product packaging for the products associated with the manufacturer. For example, in the latter case the Operator may liaise directly with a factory charged with the task of producing packaging that is to bear computer readable codes disclosed herein.

Under a third use case, the Operator may produce a set of computer-readable codes, each encoding a random number produced in accordance with the techniques disclosed herein. The computer-readable codes may be stored in a data file which is then supplied to a manufacturer or the factory associated with the manufacturing of the product on which the codes must be placed. Thus, the manufacturer or the factory manages the process of getting the computer-readable codes on the relevant packaging.

Referring again to FIG. 3, each Product 300 is mapped to a Set 302 of unique IDs, and each Set 302 of unique IDs is mapped to Information 304 provisioned in the Information Database 18. Broadly, the Information 304 may include any information about the real-world object 14. For example, consider the case where the real-world object 14 comprises the Printer 200. In this case, the Information 304 may comprise information about the printer in the form of a user guide, a troubleshooting guide, warranty information etc. Further, the Information 304 may also include about the type of consumables that may safely be used with the printer. For example, said consumables may include information about replacement ink cartridges for the printer. In some embodiments, the Information 304 may include order information to facilitate the purchasing of consumables associated with the printer. In one embodiment, said order information may be provided in the form of a pre-populated order page that is presented to a user so that the user may complete the order with an online vendor.

In order to retrieve information associated with a product, in one embodiment the user is required to use the Lookup Application 10 in order to scan the CRC 16, as will now be explained, with reference to FIG. 5 of the drawings. Referring to FIG. 5, the user launches that Lookup Application 10, and activates a “scan” button (block 500) of the Lookup Application 10 to trigger a Scan Function. This causes a camera of the mobile Phone 12 to be activated--an onscreen viewfinder for the camera is turned on. The consumer then performs the user-actions of (a) pointing the camera at the CRC 16, and (b) shooting an image of the CRC 16. The image of the CRC 16 may be stored as image data in a memory of the Phone 12.

At block 502, the Lookup Application 10 generates an Information Lookup Request based on the image data. For this purpose, the Lookup Application 10 is configured to process the image data to generate said Information Lookup Request which is transmitted to the information Server 20. Said processing may include decoding the computer-readable code in the image data thereby to obtain a unique identifier associated with said computer-readable code. To enable the decoding, the Lookup Application 10 may comprise a decode function. In one embodiment, the Information Lookup Request may include the unique identifier. Additionally, the Information Lookup Request may also include the actual image data. In some cases, the Lookup Application 10 may not be provisioned with the decode function. In such cases, the Lookup Application 10 may be configured to transmit the actual image data comprising the actual computer readable code 16 to the Information Server 20 so that the Information Server 20 may perform the decoding in order to obtain the computer-readable code.

At block 504, the Lookup Application 10 sends the Information Lookup Request to the Information Server 20 configured to process said Lookup request. Typically, the Information Server 20 may be accessible via the World Wide Web, and may comprise a plurality of computing resources organized in accordance with a cloud-based computer architecture. The Lookup Server 20 and the Phone 12 may be communicatively coupled using well-known technologies. For example, the Phone 12 may communicate with the Lookup Server 20 by means of a cellular network, which is used for transmission of the authentication request.

In response to receiving the Information Lookup Request, the Information Server 20 generates an Information Lookup Response based on an Information Server Lookup process and transmits said Information Lookup Response to the Phone 12. Thus, at block 506 the Lookup Application 10 receives the Information Lookup Response and displays the information contained in said response to the user.

In one embodiment, the Information Server Lookup process may include using the unique identifier associated with a Information Lookup Request as a key to retrieve any information associated with said unique identifier from the Information Database 18.

Provisioning of the information in the Information Database 18 may be the responsibility of manufacturers/vendors associated with products. However, in some cases the Operator of the Information Service described herein may assist in the provisioning of the Information Database 18.

One advantage of the techniques disclosed herein is that the Information Database 18 is a private database which allows for the information provisioned in said database to be carefully curated. Thus, the information in the Information Database 18 may be highly relevant to a particular product and hence very useful to a user who incurs the overhead of performing the scan described herein in order to receive said information.

In one embodiment, the Information Server 20 may be configured to facilitate a registration process to register each new user who uses the Information Service. As a result of said registration process, each user of the Information Service will be identifiable by said user's login information which may also include a device ID associated with the client device associated with said user. Since each identifier encoded in a CRC 16 is unique, it is possible to assign each instance of a manufactured product to a particular user. This binding between a user and a particular instance of a product may be used to provide information unique to said product. For example, instances of products that are part of say a product recall program may be identified and then the users associated with said product may be proactively provided with recall information without said user having to perform any scan at all, other than the initial scan to register the product.

The features/functions of the platform and client app described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures. Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

A computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database module might include other similar instrumentalities for allowing computer programs or other instructions or data to be loaded into computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,”“traditional,”“normal,”“standard,”“known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, for providing product information associated with a manufactured product, comprising:
generating a unique identifier for said product;
encoding said identifier in a Computer Readable Code (CRC);
associating said CRC with said product;
maintaining a database comprising product information associated with said product indexed based on said unique identifier; and
providing a lookup application to capture an image of said CRC and to engage in a lookup process with said database to retrieve said product information.

2. The method of claim one when said unique identifier is unique across all instances of said product by a manufacturer.

3. The method of claim 1 wherein said database is secure database.

4. The method of claim 1, wherein said database is a private database.

5. The method of claim 1, wherein said product information is selected from the group consisting of a user manual, an installation guide, and information consumables compatible with the product.

6. The method of claim 1, wherein said lookup application is configured to require a unique username and password combination for a user operating the lookup application to obtain product information from the database.

7. The method of claim 6, further comprising mapping the username and password combination to the unique identifier to identify to the manufacturer that particular product associated with the user.

8. The method of claim 7, wherein the lookup application is configured to engage in a registration process with the database to register said user as a purchaser of the product.

9. A system for providing product information associated with a product, comprising:
an information server provisioned with a database, said database comprising product information indexed by a set of unique identifiers associated with a manufactured product; wherein each instance of the manufactured product is assigned a unique identifier from the set; and
a lookup application provisioned in a mobile phone of the user and configured to perform a lookup process with the information server to retrieve the product information.

10. The system of claim 1 wherein each unique identifier in the set of unique identifiers is associated with a Computer Readable Code (CRC) that embeds said unique identifier therein and is physically associated with a particular instance of the product.

11. The system of claim 10, wherein said lookup application supports a scan function whereby an image of the CRC associated with the product is captured to retrieve the unique identifier embedded therein.

12. The system of claim 11, wherein said lookup application is configured to retrieve the unique identifier from the CRC and to transmit same to the information server as part of the lookup process.

13. The system of claim 11, wherein said lookup application is configured to transmit the CRC to the information server as part of the lookup process; and the information server is configured to retrieve the unique identifier from the CRC.

14. The system of 13, wherein the information server is configured to use the unique identifier to retrieve the product information from the database.

15. The system of claim 14, wherein the information surveys configured to transmit the retrieve product information to the lookup application.

16. The system of claim 15, wherein the lookup application runs on a client device and is wirelessly coupled to information server via a wide area network.
